(19) United States
(12) Patent Application Publication
(10) Pub. No.: US 2020/0144953 A1
(43) Pub. Date: May 7, 2020

(54) BRUSHLESS DC MOTOR WITH AUTOMATIC RECORD OF ABNORMAL OPERATION AND METHOD THEREFOR

(71) Applicant: Delta Electronics, Inc., Taoyuan City (TW)

(72) Inventors: Chia-Feng WU, Taoyuan City (TW); Chien-Sheng LIN, Taoyuan City (TW); Jou-Sheng WANG, Taoyuan City (TW)

(21) Appl. No.: 16/425,934

(22) Filed: May 29, 2019

(30) Foreign Application Priority Data
Nov. 7, 2018 (CN) 201811318256.1

(51) Int. Cl. H02P 29/024; G05B 23/02

(52) U.S. Cl. CPC H02P 29/024; G05B 2219/24053; G05B 23/0264

(57) ABSTRACT

A brushless DC motor with automatic record of abnormal operation includes an integrated circuit chip electrically connected to a drive circuit of the brushless DC motor. The integrated circuit chip includes a central processing unit, and a flash memory and a detection unit connected to the central processing unit. When the detection unit receives a detection signal from the drive circuit and the central processing unit determines that the brushless DC motor is in an abnormal operation state, the central processing unit generates an abnormal operation data including an error code so that the flash memory automatically stores the abnormal operation data. The present disclosure further includes a method of automatically recording abnormality for the brushless DC motor.

### BACKGROUND

### Technical Field

The present disclosure relates to a brushless DC motor, and more particularly to a brushless DC motor with automatic record of abnormal operation and a method therefor.

### Description of Related Art

The statements in this section merely provide background information related to the present disclosure and do not necessarily constitute prior art.

A brushless DC Motor (BLDC Motor) is a DC motor without electric brushes and commutators. Compared with the traditional brushed DC motor, the carbon brush of the traditional brushed DC motor would produce toner while the brushed DC motor operating for a long time. The accumulated toner may explode in the high temperature environment during operation of the brushed DC motor, it needs to be cleaned regularly and therefore resulted in the high maintenance cost. Therefore, the brushless DC motor is safer and more reliable than the brushed DC motor. It has the advantages of good stability, high efficiency, long working life, etc., and is widely used in different fields such as electrical appliances, automobiles, aerospace, consumer, medical, industrial automation equipment.

However, in the prior art brushless DC motor, when an abnormal condition occurs, the brushless DC motor enters a protection state, and waits for a period of time to restart the brushless DC motor. For developers (or operators, users, etc.), the developers can't get detailed information about the previous abnormal situation, so it is impossible to grasp the history of the abnormal operation of the brushless DC motor. In contrast, verification and analysis must be performed through multiple attempts (try and error) until the type of abnormal condition and the cause of occurring the abnormal condition are identified. To do this, it takes much labor and time, and it cannot improve production efficiency and improve product quality.

Therefore, how to design an improved brushless DC motor, especially the brushless DC motor with automatic recording abnormal operation function and method therefor to solve the above technical problems is an important subject studied by the inventors with the present disclosure.

### SUMMARY

The objective of the present disclosure is to provide a brushless DC motor with automatic record of abnormal operation. By automatically recording the abnormal operation function, the above-mentioned technical problems that require a lot of labor costs and time costs for the developer can be solved. And to achieve the goal of improving production efficiency and improving product quality.

In order to achieve the foregoing objective, the brushless DC motor with automatic record of abnormal operation, comprising: an integrated circuit chip electrically connected to a drive circuit of the brushless DC motor, the integrated circuit chip comprising: a detection unit, a central processing unit connected to the detection unit, and a flash memory connected to the central processing unit, wherein when the detection unit is configured to receive a detection signal from the drive circuit and the central processing unit is configured to determine that the brushless DC motor is in an abnormal operation state, the central processing unit is configured to generate abnormal operation data including an error code so that the flash memory is configured to automatically store the abnormal operation data.

Further, the error code differs depending on the type of abnormal operation data; the abnormal operation data includes one of a startup abnormality message, an operation abnormality message, an overcurrent abnormality message, an overvoltage abnormality message, a motor phase sequence abnormality message, and a current limiting abnormality message.

During operation of the brushless DC motor of the present disclosure, when the detection unit receives a detection signal from the drive circuit and the central processing unit determines that the brushless DC motor is in an abnormal operation state, the central processing unit generates an abnormal operation data including an error code so that the flash memory automatically stores the abnormal operation data. At this time, the developer can quickly obtain the detailed information of the previous abnormal condition by reading the abnormal operation data stored in the flash memory, and no need to perform through multiple attempts for verification and analysis, saving labor costs and time costs, thereby increasing production efficiency and improving product quality.

Another objective of the present disclosure is to provide a method for recording abnormality automatically with the brushless DC motor. By automatically recording the abnormal operation, the above-mentioned technical problems that require a lot of labor costs and time costs for the developer can be solved. And to achieve the goal of improving production efficiency and improving product quality.

In order to achieve the foregoing another objective, the method of automatically recording abnormality for a brushless DC motor applied to the brushless DC motor in operation, wherein the brushless DC motor has an integrated circuit chip, and the method comprising the steps of: generating, by a central processing unit in the integrated circuit chip, abnormal operation data including an error code when determining that the brushless DC motor is in an abnormal operation state, and automatically storing the abnormal operation data in a flash memory in the integrated circuit chip.

Further, the method further includes: transmitting, by the central processing unit, part or all of the abnormal operation data stored in the flash memory to the system terminal when the central processing unit detects that the abnormal operation data are stored in the flash memory.

### BRIEF DESCRIPTION OF DRAWING

FIG. 1 is a schematic structural diagram of a first embodiment of a brushless DC motor with automatic record of abnormal operation according to the present disclosure,

FIG. 2 is a schematic diagram of a flash memory of the first embodiment of the brushless DC motor with automatic record of abnormal operation according to the present disclosure,

FIG. 3 is a schematic diagram of the first embodiment operating in an active mode of the brushless DC motor with automatic record of abnormal operation according to the present disclosure,

FIG. 4 is a schematic diagram of the first embodiment operating in a passive mode of the brushless DC motor with automatic record of abnormal operation according to the present disclosure,

FIG. 5 is a flowchart showing an embodiment of a method of automatically recording abnormality for the brushless DC motor according to the present disclosure, and

FIG. 6 is a flowchart showing another embodiment of the method of automatically recording abnormality for the brushless DC motor according to the present disclosure.

### DETAILED DESCRIPTION

The embodiments of the present disclosure are described by way of specific examples, and those skilled in the art can readily appreciate the other advantages and functions of the present disclosure. The present disclosure may be embodied or applied in various other specific embodiments, and various modifications and changes can be made without departing from the spirit and scope of the present disclosure.

It should be understood that the structures, the proportions, the sizes, the number of components, and the like in the drawings are only used to cope with the contents disclosed in the specification for understanding and reading by those skilled in the art, and it is not intended to limit the conditions that can be implemented in the present disclosure, and thus is not technically significant. Any modification of the structure, the change of the proportional relationship, or the adjustment of the size, should be within the scope of the technical contents disclosed by the present disclosure without affecting the effects and the achievable effects of the present disclosure.

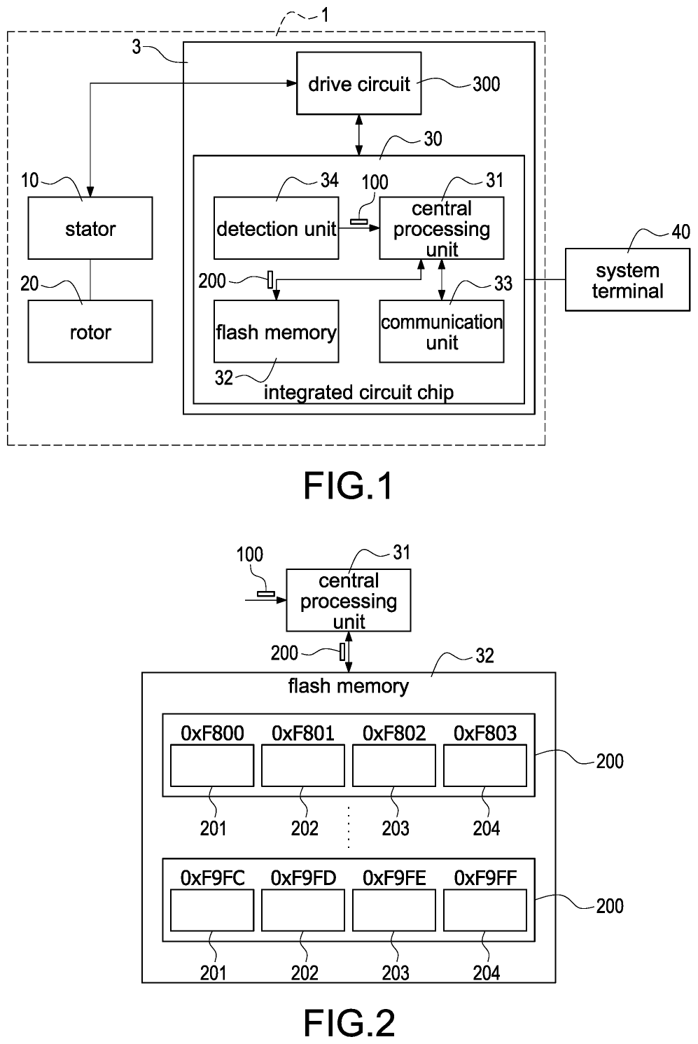

The technical content and detailed description of the present disclosure will be described below in conjunction with the drawings. Referring to FIG. 1 and FIG. 2, FIG. 1 is a schematic structural diagram of a first embodiment of a brushless DC motor with automatic record of abnormal operation according to the present disclosure; FIG. 2 is a schematic diagram of a flash memory of the first embodiment of the brushless DC motor with automatic record of abnormal operation according to the present disclosure.

The first embodiment of the brushless DC motor 1 with automatic record of abnormal operation of the present disclosure includes a stator 10, a rotor 20 and a control circuit 3. The control circuit 3 includes an integrated circuit chip 30 and a drive circuit 300 (for example, it can be a bridge circuit) electrically connected to the integrated circuit chip 30. The brushless DC motor 1 with simple structure has a permanent magnet and two sets of (four) coils, and the two sets of coils alternately interact. The permanent magnet is disposed on the rotor 20, the coils are wound on the stator 10, and the drive circuit 300 is electrically connected to the coils of the stator 10 for driving the brushless DC motor 1, but the present disclosure is not limited thereto.

Further, the integrated circuit chip 30 is electrically connected to the stator 10 via the drive circuit 300. In the first embodiment of the present disclosure, the integrated circuit chip 30 may be one of a micro control unit (MCU), a micro processor unit (MPU), an application-specific integrated circuit (ASIC), and a system on a chip (SoC). The integrated circuit chip 30 includes a central processing unit 31, a flash memory 32, a communication unit 33, and a detection unit 34. The central processing unit 31 is electrically connected to the flash memory 32, the communication unit 33, and the detection unit 34, respectively. The detection unit 34 may be a phase sequence abnormality detection unit, a rotation speed detection unit, a current detection unit or a voltage detection unit. The detection unit 34 is configured to detect a driving abnormality, a rotation speed, a current or a voltage of the brushless DC motor 1 to generate a detection signal 100 corresponding to the driving abnormality, the rotation speed, the current or the voltage.

Further, the central processing unit 31 may be a programmable integrated circuit. When the central processing unit 31 receives the detection signal 100 such as driving abnormality, rotation speed, current or voltage from the detection unit 34, and further determines whether the brushless DC motor 1 is in an abnormal operation state, that is to determine whether the brushless DC motor 1 is abnormally operated. For example, the abnormal operation state may be one of motor phase sequence abnormality, overvoltage abnormality, overcurrent abnormality, startup state abnormality, in-operation state abnormality, and current limit abnormality, as shown in FIG. 2. When the central processing unit 31 determines that the brushless DC motor 1 is in one or more than one of the abnormal operation states, the central processing unit 31 generates abnormal operation data 200 including an error code 202 so that the flash memory 32 automatically stores the abnormal operation data 200. Further, the error code 202 differs depending on the type of abnormal operation data 200. The abnormal operation data 200 includes one of a startup abnormality message, an operation abnormality message, an overcurrent abnormality message, an overvoltage abnormality message, a motor phase sequence abnormality message, and a current limiting abnormality message. See Table 1 below for details.

TABLE 1
Relationship between abnormal operation data and error code

| abnormal | | | | PWM | |
|---|---|---|---|---|---|
| operation | error | | PWM | Fre- | |
| data | code | UART [symbol] I²C [symbol] SPI | Duty | quency | I/O |
| startup | 00000001 | 0x01 | 10% | 100 Hz | HIGH |
| abnormality | | | | | |
| operation | 00000010 | 0x02 | 20% | 200 Hz | HIGH |
| abnormality | | | | | |
| overcurrent | 00000100 | 0x04 | 30% | 300 Hz | HIGH |
| abnormality | | | | | |
| overvoltage | 00001000 | 0x08 | 40% | 400 Hz | HIGH |
| abnormality | | | | | |
| motor phase | 00010000 | 0x10 | 50% | 500 Hz | HIGH |
| sequence | | | | | |
| abnormality | | | | | |
| current | 00100000 | 0x20 | 60% | 600 Hz | HIGH |
| limiting | | | | | |
| abnormality | | | | | |

As described above, when the abnormal operation data 200 is the startup abnormality message, the error code 202 corresponding to the abnormal operation data 200 is 00000001, and analog or digital data corresponding to different abnormal operation states may be transmitted through UART, I²C, SPI, pulse-width modulation (PWM) or I/O port to an external system terminal 40, which will be described in detail later. For example, as shown in Table 1, when the error code 202 corresponding to the abnormal operation data 200 is 00000001, the data of “0x01”, “PWM Duty=10%”, “PWM Frequency=100 Hz” or “HIGH level of a specific I/O pin” can be transmitted through UART, I²C, SPI to the system terminal 40. Therefore, the developer can know that the brushless DC motor 1 is under the “startup abnormality” from the data displayed by the system terminal 40. For another example, when the error code 202 corresponding to the abnormal operation data 200 is 00000100, the data of “0x04”, “PWM Duty=30%”, “PWM Frequency=300 Hz” or “HIGH level of a specific I/O pin” can be transmitted through UART, I²C, SPI to the system terminal 40. Therefore, the developer can know that the brushless DC motor 1 is under the “overcurrent abnormality” from the data displayed by the system terminal 40. The above exemplified numerical values are for convenience and clarity of illustration and are not intended to limit the present disclosure.

Further, when the central processing unit 31 receives the detection signal 100 such as driving abnormality, rotation speed, current or voltage from the detection unit 34, and further confirms that the brushless DC motor 1 is in an abnormal operation state, the central processing unit 31 restarts the brushless DC motor 1 after a protection time has elapsed.

The flash memory 32 is electrically connected to the central processing unit 31 for receiving instructions outputted by the central processing unit 31. The Flash memory 32 is a non-volatile and electronically erasable, programmable ROM (PROM). It is allowed to be erased or written multiple times during operation, mainly for general data storage, and for exchanging transmission data between computers and other digital products. Although flash memory is technically similar to EEPROM, but the erase cycle of old type EEPROM is quite slow, in contrast to flash memory, flash memory has an advantage of significant speed when writing large amounts of data in larger erase sectors.

In the first embodiment of the present disclosure, the flash memory 32 may be one of a NOR Flash, a NAND Flash, a 3D NAND Flash, a Single-Level Cell (SLC), a Multi-Level Cell (MLC), a Triple-Level Cell (TLC) or a Quad-Level Cell (QLC). As shown in FIG. 2, in the first embodiment of the present disclosure, the abnormal operation data 200 stored in the flash memory 32 may include a rotation speed value 201, an error code 202, and a pulse width modulation command input value 203 (PWM IN) and a reserved value 204 (the written data are not defined). The written addresses of the first abnormal operation data 200 are 0xF800, 0xF801, 0xF802, 0xF803, and the written addresses of the last abnormal operation data 200 are 0xF9FC, 0xF9FD, 0xF9FE, 0xF9FF. In addition, in other embodiments of the present disclosure, the pulse width modulation command input value 203 may also be replaced by at least one of a voltage value (not shown) and a current value (not shown).

When the flash memory 32 has insufficient storage space during storage of the abnormal operation data 200, the central processing unit 31 causes the flash memory 32 to clear the storage space within the flash memory 32, and then causes the flash memory 32 to store the abnormal operation data 200. The “clearing storage space” is to partially delete or completely delete the abnormal operation data 200 stored in the flash memory 32. In the first embodiment of the present disclosure, the “clearing storage space” is completely deleted the abnormal operation data 200 stored in the flash memory 32.

As shown in FIG. 1, the communication unit 33 is electrically connected to the central processing unit 31, and the central processing unit 31 transmits part or all of the abnormal operation data 200 stored in the flash memory 32 to the system terminal 40 through the communication unit 33. The communication unit 33 may be a UART, an I²C, an SPI, a pulse width modulation (PWM) or an I/O port for transmitting the abnormal operation data 200. In the first embodiment of the present disclosure, the error code 202 of the abnormal operation data 200 be transmitted through UART, I²C, SPI, pulse-width modulation (PWM) or I/O port according to an analog or digital data corresponding to different abnormal operation states to the external system terminal 40. As shown in Table 1 above, and the pulse width modulation (PWM) also includes PWM Duty and PWM Frequency.

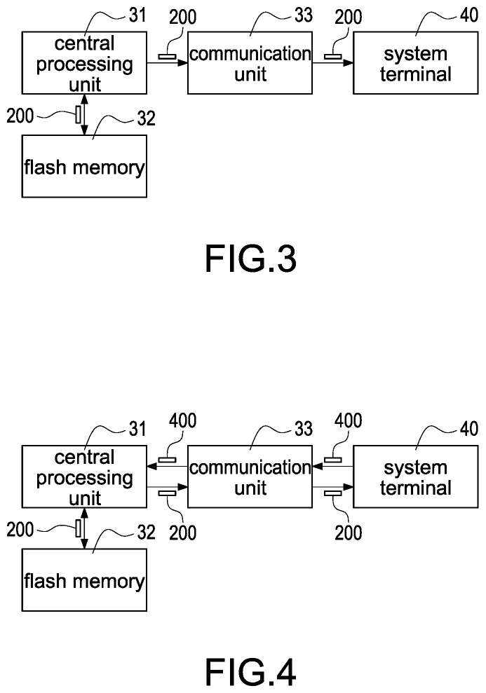

Refer to FIG. 3 and FIG. 4, which are schematic diagrams of the first embodiment respectively operating in an active mode and in a passive mode of the brushless DC motor with automatic record of abnormal operation according to the present disclosure. The active mode means that the central processing unit 31 actively transmits the abnormal operation data 200 to the system terminal 40 through the communication unit 33. The passive mode means that the central processing unit 31 receives a transmission request sent from the system terminal 40, and then passively transmits the abnormal operation data 200 to the system terminal 40 through the communication unit 33. The detail operations are described as follows.

As shown in FIG. 3, in the active mode, when the central processing unit 31 determines that the brushless DC motor 1 is in an abnormal operation state according to the detection signal 100, the central processing unit 31 generates abnormal operation data 200 including an error code 202, and the flash memory 32 is automatically stored in the abnormal operation data 200. Meanwhile, the central processing unit 31 automatically extracts part or all of the abnormal operation data 200 stored in the flash memory 32, and then transmits part or all of the abnormal operation data 200 to the system terminal 40 through the communication unit 33.

As shown in FIG. 4, in the passive mode, when the central processing unit 31 detects that the system terminal 40 sends a request command 400 through the communication unit 33, the central processing unit 31 extracts part or all of the abnormal operation data 200 stored in the flash memory 32 according to the request command 400, and then transmits part or all of the abnormal operation data 200 to the system terminal 40 through the communication unit 33. In the embodiment of the present disclosure, the system terminal 40 may be one of a cloud server, a database, a workstation, a notebook computer, and a portable smart device.

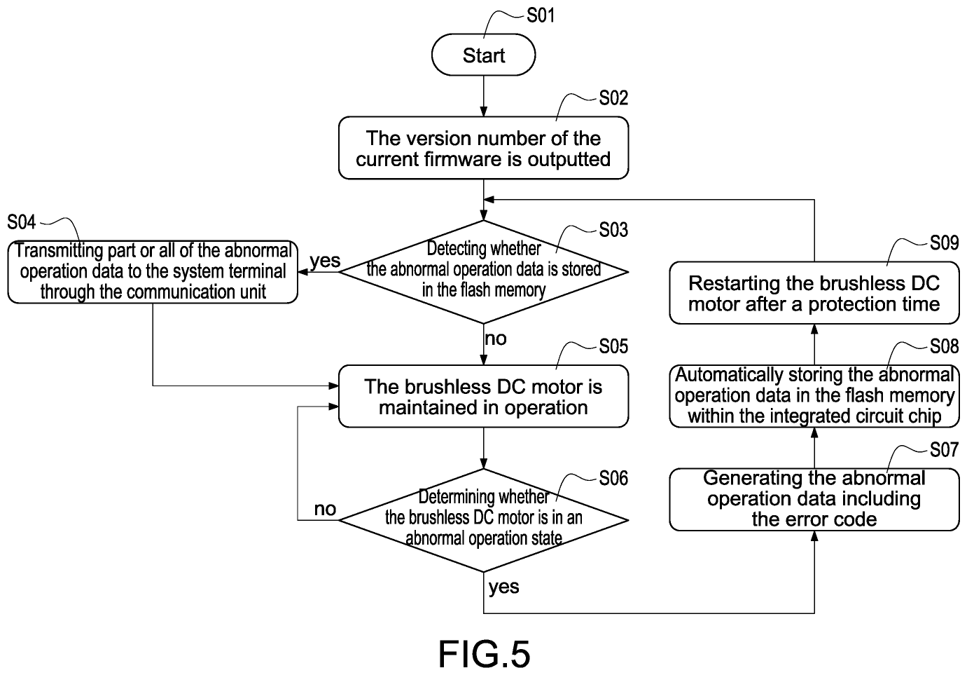

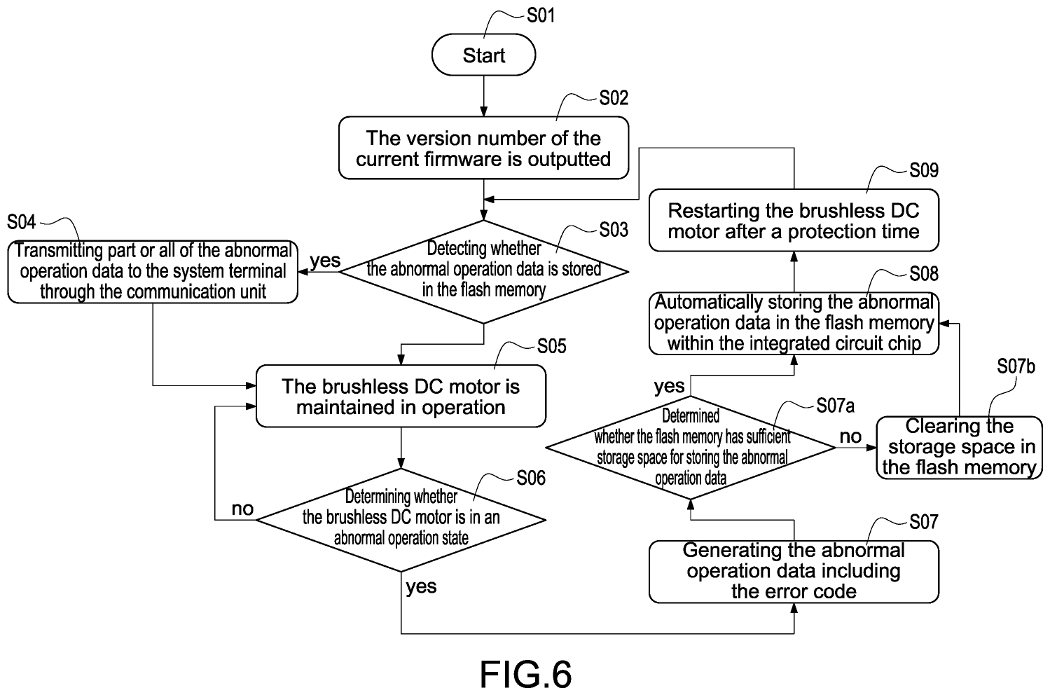

Please refer to FIG. 5 and FIG. 6. FIG. 5 is a flowchart showing an embodiment of a method for recording abnormality automatically with the brushless DC motor to the present disclosure, and the method is applied to the brushless DC motor 1 in operation. After the start (step S01), the version number of the current firmware is outputted (step S02) for confirmation by the user or developer. Afterward, the central processing unit 31 starts detecting whether the abnormal operation data 200 is stored in the flash memory 32 (step S03). If the central processing unit 31 detects that the abnormal operation data 200 is stored in the flash memory 32, the central processing unit 31 transmits part or all of the abnormal operation data 200 to the system terminal 40 through the communication unit 33 (step S04).

Afterward, the brushless DC motor 1 is maintained in operation (step S05), and the central processing unit 31 determines whether the brushless DC motor 1 is in an abnormal operation state (step S06). If the central processing unit 31 determines that the brushless DC motor 1 is in the abnormal operation state according to the detection result of the detection unit 34, the central processing unit 31 of the integrated circuit chip 30 correspondingly generates the abnormal operation data 200 including the error code 202 (step S07), and the abnormal operation data 200 are automatically stored in the flash memory 32 within the integrated circuit chip 30 (step S08). The active mode means that the central processing unit 31 actively transmits the abnormal operation data 200 to the system terminal 40 through the communication unit 33. The passive mode means that the central processing unit 31 receives a transmission request sent from the system terminal 40, and then passively transmits the abnormal operation data 200 to the system terminal 40 through the communication unit 33. In step S06, when the brushless DC motor 1 is determined not in an abnormal operation state, that is, the brushless DC motor 1 is in a normal operation, and the brushless DC motor 1 is continuously operated. Finally, after the flash memory 32 stores the abnormal operation data 200, the central processing unit 31 restarts the brushless DC motor 1 after a protection time (step S09), and then returns to step S03 to continuously perform detection and control.

Referring to FIG. 6, which is a flowchart showing another embodiment of the method for recording abnormality automatically with the brushless DC motor to the present disclosure. It is substantially the same as the foregoing embodiment, and is applied to the brushless DC motor 1 in operation, but one more step is added after the step S07. Before the flash memory 32 stores the abnormal operation data 200, it is determined whether the flash memory 32 has sufficient storage space for storing the abnormal operation data 200 (step S07a). If the storage space of the flash memory 32 is insufficient, the central processing unit 31 causes the flash memory 32 to clear the storage space in the flash memory (step S07b). Afterward, the flash memory 32 is caused to store the abnormal operation data 200 into the flash memory 32 within the integrated circuit chip 30 (step S08). The “clearing storage space” is to partially delete (for example, delete from the oldest part of the data) or delete all of the abnormal operation data 200 stored in the flash memory 32.

At this time, the developer can quickly obtain the detailed information of the previous abnormal condition about the brushless DC motor 1 by reading the abnormal operation data 200 stored in the flash memory 32, and no need to performed through multiple attempts for verification and analysis, saving labor costs and time costs, thereby increasing production efficiency and improving product quality.

The above is only a detailed description and drawings of the preferred embodiments of the present disclosure, but the features of the present disclosure are not limited thereto, and are not intended to limit the present disclosure. All the scope of the present disclosure shall be subject to the scope of the following claims. The embodiments of the spirit of the present disclosure and its similar variations are intended to be included in the scope of the present disclosure. Any variation or modification that can be easily conceived by those skilled in the art in the field of the present disclosure can be covered by the following claims.

What is claimed is:

1. A brushless DC motor with automatic record of abnormal operation, comprising:
an integrated circuit chip electrically connected to a drive circuit of the brushless DC motor, the integrated circuit chip comprising:
a detection unit,
a central processing unit connected to the detection unit, and
a flash memory connected to the central processing unit,
wherein when the detection unit is configured to receive a detection signal from the drive circuit and the central processing unit is configured to determine that the brushless DC motor is in an abnormal operation state, the central processing unit is configured to generate an abnormal operation data including an error code so that the flash memory is configured to automatically store the abnormal operation data.

2. The brushless DC motor with automatic record of abnormal operation in claim 1, wherein the error code differs depending on the type of the abnormal operation data; the abnormal operation data includes one of a startup abnormality message, an operation abnormality message, an overcurrent abnormality message, an overvoltage abnormality message, a motor phase sequence abnormality message, and a current limiting abnormality message.

3. The brushless DC motor with automatic record of abnormal operation in claim 1, wherein when the flash memory has insufficient storage space during storage of the abnormal operation data, the central processing unit is configured to cause the flash memory to clear the storage space within the flash memory, and then cause the flash memory to store the abnormal operation data.

4. The brushless DC motor with automatic record of abnormal operation in claim 3, wherein the abnormal operation data stored in the flash memory are partially deleted or completely deleted.

5. The brushless DC motor with automatic record of abnormal operation in claim 1, wherein the abnormal operation data include at least one of a rotation speed value, a current value, a voltage value and a pulse width modulation command input value.

6. The brushless DC motor with automatic record of abnormal operation in claim 1, wherein the detection unit is a phase sequence abnormality detection unit, a rotation speed detection unit, a current detection unit or a voltage detection unit, and the detection unit is configured to detect a driving abnormality, a rotation speed, a current or a voltage of the brushless DC motor to generate a detection signal corresponding to the driving abnormality, the rotation speed, the current or the voltage.

7. The brushless DC motor with automatic record of abnormal operation in claim 1, when the detection unit is configured to receive the detection signal from the drive circuit and the central processing unit is configured to determine that the brushless DC motor is in the abnormal operation state, the central processing unit is configured to restart the brushless DC motor after a protection time has elapsed.

8. The brushless DC motor with automatic record of abnormal operation in claim 1, wherein the integrated circuit chip is configured to transmit the abnormal operation data through UART, I²C, SPI, pulse-width modulation or I/O port.

9. The brushless DC motor with automatic record of abnormal operation in claim 1, further comprising:
a communication unit electrically connected to the central processing unit,
when the central processing unit is configured to detect that the abnormal operation data are stored in the flash memory, the central processing unit is configured to automatically transmit part or all of the abnormal operation data to a system terminal through the communication unit.

10. The brushless DC motor with automatic record of abnormal operation in claim 1, further comprising:
a communication unit electrically connected to the central processing unit,
when the central processing unit is configured to detect that a system terminal sends a request command through the communication unit, the central processing unit is configured to transmit part or all of the abnormal operation data to the system terminal through the communication unit according to the request command.

11. A method of automatically recording abnormality for a brushless DC motor applied to the brushless DC motor in operation, wherein the brushless DC motor has an integrated circuit chip, and the method comprising the steps of:
generating, by a central processing unit in the integrated circuit chip, an abnormal operation data including an error code when determining that the brushless DC motor is in an abnormal operation state, and
automatically storing the abnormal operation data in a flash memory in the integrated circuit chip.

12. The method of automatically recording abnormality for the brushless DC motor in claim 11, wherein the error code differs depending on the type of the abnormal operation data, the abnormal operation data includes one of a startup abnormality messages, an operation abnormality message, an overcurrent abnormality message, an overvoltage abnormality message, a motor phase sequence abnormality message, and a current limiting abnormality message.

13. The method of automatically recording abnormality for the brushless DC motor in claim 11, further comprising the steps of:
determining, by the central processing unit, whether the flash memory has sufficient storage space for storing the abnormal operation data before the flash memory stores the abnormal operation data, and
causing, by the central processing unit, the flash memory to clear the storage space in the flash memory, and then causing the flash memory to store the abnormal operation data into the flash memory within the integrated circuit chip when the storage space of the flash memory is insufficient.

14. The method of automatically recording abnormality for the brushless DC motor in claim 13, wherein the abnormal operation data stored in the flash memory are partially deleted or completely deleted, and the abnormal operation data include at least one of a rotation speed value, a current value, a voltage value and a pulse width modulation command input value.

15. The method of automatically recording abnormality for the brushless DC motor in claim 11, further comprising the step of:
detecting, by the central processing unit, a driving abnormality, a rotation speed, a current or a voltage of the brushless DC motor to generate a detection signal corresponding to the driving abnormality, the rotation speed, the current or the voltage, and transmitting the detection signal to the central processing unit for the central processing unit to determine whether the brushless DC motor is in the abnormal operation state.

16. The method of automatically recording abnormality for the brushless DC motor in claim 11, further comprising the step of:
restarting, by the central processing unit, the brushless DC motor after a protection time has elapsed when the brushless DC motor is in the abnormal operation state and after the abnormal operation data are stored in the flash memory.

17. The method of automatically recording abnormality for the brushless DC motor in claim 11, further comprising the step of:
transmitting, by the central processing unit, part or all of the abnormal operation data stored in the flash memory to the system terminal when the central processing unit detects that the abnormal operation data are stored in the flash memory.

18. The method of automatically recording abnormality for the brushless DC motor in claim 17, wherein in an active mode, when the central processing unit detects that the abnormal operation data are stored in the flash memory, the central processing unit automatically transmits part or all of the abnormal operation data to a system terminal through a communication unit.

19. The method of automatically recording abnormality for the brushless DC motor in claim 17, wherein in a passive mode, when the central processing unit detects that a system terminal sends a request command through a communication unit, the central processing unit transmits part or all of the abnormal operation data to the system terminal through the communication unit according to the request command.
